(19) United States
(12) Patent Application Publication
(10) Pub. No.: US 2012/0034399 A1
(43) Pub. Date: Feb. 9, 2012

(54) Injection-Molded Composite Container

(75) Inventors: Scott W. Middleton, Oshkosh, WI (US); Brian R. O'Hagan, Appleton, WI (US)

(73) Assignee: GRAPHIC PACKAGING INTERNATIONAL, INC., Marietta, GA (US)

(21) Appl. No.: 13/198,039

(22) Filed: Aug. 4, 2011

Related U.S. Application Data
(60) Provisional application No. 61/371,296, filed on Aug. 6, 2010.

(51) Int. Cl. B32B 1/02; B29C 45/14

(52) U.S. Cl. 428/34.1; 425/588; 264/277

(57) ABSTRACT

Constructs including a blank and a body formed from liquid molding material are provided. The blank may be hermetically sealed to the body. For example, a mold assembly may injection mold the blank to the body. The mold assembly may include a male mold and a female mold that cooperatively define a first cavity and a second cavity. The first cavity may receive a peripheral margin of the blank and the second cavity may receive the remainder of the blank. Liquid molding material may be directed into the first cavity to form the body of the construct. The liquid molding material may be directed into the first cavity in a manner that avoids bending the peripheral margin of the blank such that a tight seal is established between the blank and the body of the construct and the blank retains a planar configuration.

### CROSS-REFERENCE TO RELATED APPLICATION

This application claims the benefit of U.S. Provisional Patent Application No. 61/371,296, which was filed on Aug. 6, 2010. The disclosure of the referenced application is hereby incorporated herein in its entirety by reference.

### FIELD OF THE INVENTION

The present disclosure relates to embodiments of injection molded constructs. The constructs may be formed from a blank and liquid molding material.

### BACKGROUND

Combining two or more materials to define a single structure is known to provide benefits. In this regard, a first material having a desirable property may be combined with a second material having a desirable property to define a structure having both desirable properties. However, there remains a need in the art for combinations of two or more materials in structures that define new and different properties and methods and apparatuses for forming the structures.

### SUMMARY OF THE DISCLOSURE

In one embodiment a construct is provided. The construct may include a blank having a first surface and a second surface configured in an opposing relationship, the first surface and the second surface extending to a peripheral margin of the blank. The construct may also include an injection-molded body comprising a rim, a base defining an inner groove engaged with the peripheral margin of the blank, and a sidewall that substantially continuously extends from the base to the rim around a periphery of the injection-molded body.

In an additional embodiment a mold assembly is provided. The mold assembly may include a male mold defining a first blank receiving face and an outer face and a female mold defining a second blank receiving face and an inner face. The male mold and the female mold may be configured to cooperatively define a first cavity defined between the inner face of the female mold and the outer face of the male mold and configured to receive a peripheral margin of a blank and a second cavity defined between the first blank receiving face of the male mold and the second blank receiving face of the female mold and configured to receive a remaining portion of the blank. The mold assembly may further include at least one passageway configured to direct a liquid molding material through two or more ports into the first cavity. The ports may be configured to be positioned on opposing sides of the peripheral margin of the blank.

In another embodiment a method for forming a construct is provided. The method may include having (e.g., by providing) a mold assembly comprising a male mold defining a first blank receiving face and an outer face and a female mold defining a second blank receiving face and an inner face. The method may also include inserting a blank into the mold assembly such that a peripheral margin of the blank is received in a first cavity defined between the inner face of the female mold and the outer face of the male mold and a remaining portion of the blank is received in a second cavity defined between the first blank receiving face of the male mold and the second blank receiving face of the female mold. Additionally, the method may include directing a liquid molding material through at least one passageway and out of two or more ports defined in the mold assembly into the first cavity on opposing sides of the peripheral margin of the blank.

The construct, mold assembly, and method provided herein may be configured to provide the peripheral edge of the blank with a substantially planar configuration that may improve the bond between the blank and the frame. This planar configuration may be realized through employing one or more of the techniques and configurations disclosed herein. Other aspects of this disclosure will become apparent from the following.

### BRIEF DESCRIPTION OF THE DRAWINGS

In the following, reference is made to the accompanying drawings, which are not necessarily drawn to scale and most of which are schematic, and wherein:

FIG. 1 is a plan view of blank, in accordance with a first embodiment of this disclosure.

FIG. 1A is the blank of FIG. 1 except for schematically illustrating that the blank may define a different material composition at the peripheral margin than at a remaining portion circumscribed by the peripheral margin.

FIG. 2 is an enlarged cross-sectional view of a portion of the blank of FIG. 1, or an enlarged cross-sectional view of a portion of a laminate from which the blank of FIG. 1 may be constructed, with the cross section taken perpendicular to the thickness of the blank or laminate (e.g., with the cross section taken along line 4-4 of FIG. 3).

FIG. 3 is a top plan view of a tray comprising, consisting of, or consisting essentially of a frame that is injection-molded onto the periphery of the blank of FIG. 1, in accordance with the first embodiment.

FIG. 4 is a cross-sectional view of the tray, with the cross-section taken along line 4-4 of FIG. 3, and FIG. 4 is representative of substantially all cross sections that both extend perpendicular to the thickness of the blank and extend through the central axis of the tray.

FIG. 5 is an enlarged view of a portion of FIG. 4.

FIG. 6 is an elevation view of the tray, and FIG. 6 is representative of substantially all elevation views of the tray.

FIG. 7 is a cross-sectional view of the tray in a closed mold assembly, with the cross-section corresponding to the cross section of FIG. 4, and FIG. 7 is representative of all cross sections that both extend perpendicular to the thickness of the blank and extend through the central axes of the tray and closed blank, except that FIG. 7 does not show any injection port(s) (e.g., gates) in the mold assembly.

FIG. 8 is an enlarged view of a portion of FIG. 7, with the mold assembly fully closed but not including the blank, except that a portion of the periphery of the blank is schematically illustrated by dashed lines.

FIG. 9 is like FIG. 8, except that FIG. 9 shows passageways (e.g., gate(s)) for injecting liquid molding material into an annular cavity of the mold assembly, in accordance with a first version of the first embodiment.

FIG. 10 is like FIG. 8, except that FIG. 10 shows passageways (e.g., gates) for injecting liquid molding material into the annular cavity of the mold assembly, in accordance with a second version of the first embodiment.

FIG. 10A is like FIG. 10, except that the annular cavity includes an increased cross-sectional area proximate a blank, in accordance with another version of the first embodiment.

FIG. 10B is like FIG. 10, except that the annular cavity includes a sidewall portion with a reduced minimum cross-sectional dimension, in accordance with another version of the first embodiment.

FIG. 10C is like FIG. 10, except that the annular cavity includes a sidewall portion with a reduced minimum cross-sectional dimension extending between a base portion and a rim portion of the annular cavity, in accordance with another version of the first embodiment.

FIG. 11 is a partial perspective view of a blank in relation to flows of liquid molding material received from upper and lower ports of a mold assembly, in accordance with the second version of the first embodiment.

FIG. 12 is generally like FIG. 5, except features configured to facilitate production of the tray are shown and the blank is configured in an alternate position, in accordance with the second embodiment.

### DETAILED DESCRIPTION

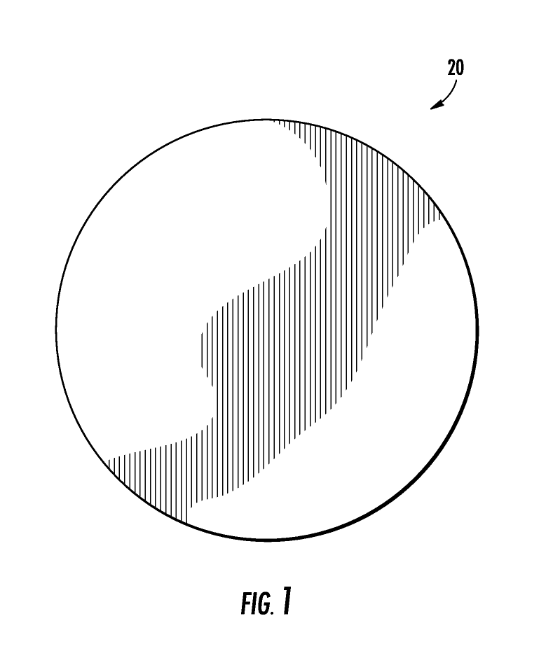

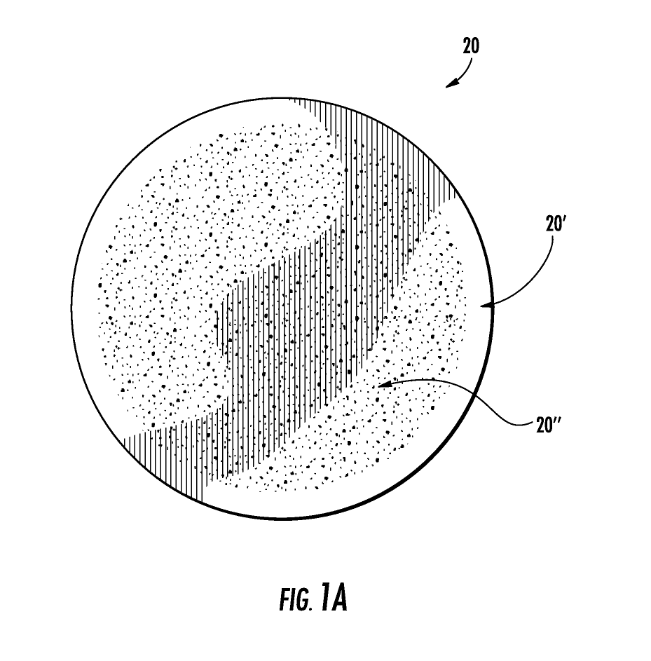

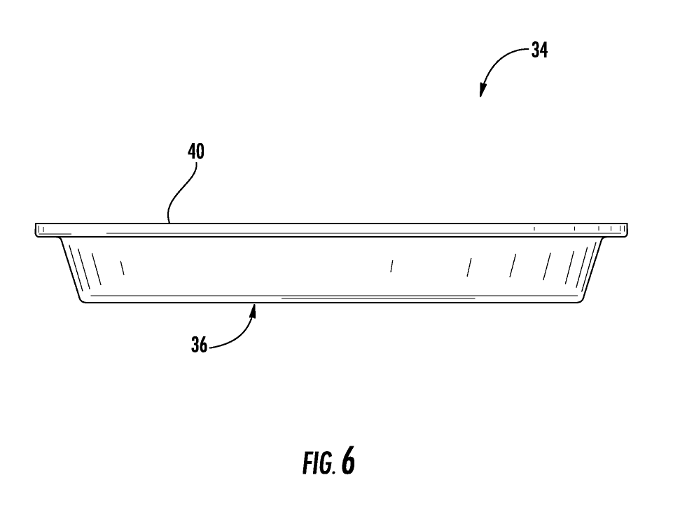

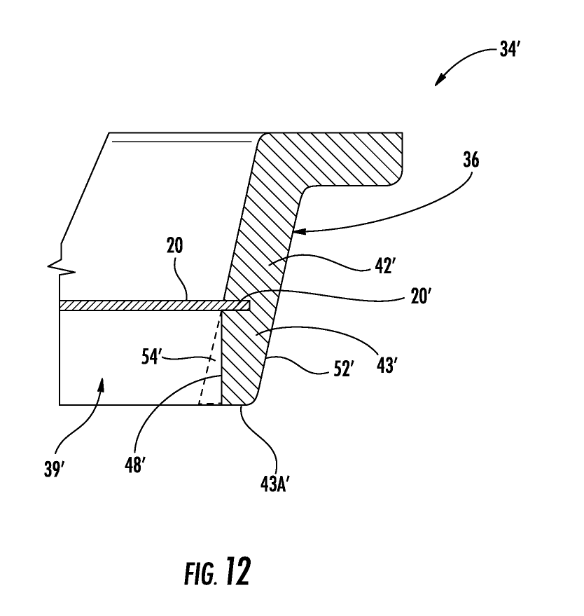

Referring now in greater detail to the drawings, in which like numerals refer to like parts throughout the several views, exemplary embodiments are disclosed in the following. More specifically, a first embodiment is initially disclosed with reference to FIGS. 1-11, and then a second embodiment is disclosed with reference to FIG. 12.

FIG. 1 illustrates a flat, substantially round, disklike blank 20 (e.g., disk) that can be formed (e.g., cut) from any suitable material, such as a laminate. As schematically shown with stippling in FIG. 1A, in some embodiments the material composition of the blank 20 may not be the same across the entirety thereof. Referring to FIG. 1A, in the illustrated embodiment a first portion of the blank (e.g., a peripheral margin 20′) comprises a first material composition (and/or defines a first material property), and a second portion of the blank (e.g., a remaining portion 20″) comprises a second material composition (and/or defines a second material property). As illustrated, the peripheral margin 20′ may circumscribe the remaining portion 20″ of the blank 20 in some embodiments. As discussed below, variations in the material composition and/or material properties of the blank 20 at different portions thereof may be beneficial in some embodiments.

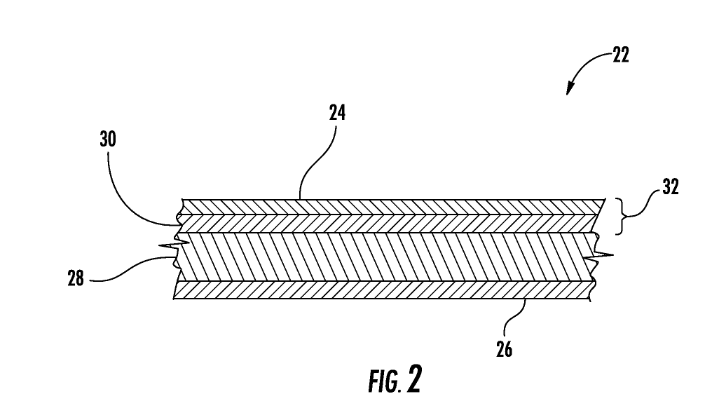

A portion of a suitable laminate 22 from which the blank 20 may be constructed is shown in FIG. 2. FIG. 2 is not drawn to scale. The laminate 22 from which the blank 20 can be formed includes more than one layer, but the laminate may be replaced with a single ply of material, such as, but not limited to, paperboard, cardboard or a polymer sheet. The laminate 22 includes upper (e.g., top) and lower (e.g., bottom) polymer layers 24, 26 (e.g., coatings and/or films) that are mounted to, and supported by, a substrate 28 positioned between the polymer layers. In accordance with the first embodiment, the substrate 28 is paperboard (e.g., a clay-coated paperboard that may also include other coatings, colorants, pictures and/or text), and each of the polymer layers 24, 26 is polyethylene terephthalate (“PETE”, “Pete” or “PET”). Alternatively, the substrate 28 may be any suitable material, such as cardboard, corrugated cardboard or a polymer sheet, and the polymer layers 24, 26 may likewise be any suitable materials. For example, the laminate 22 may be a laminate that consist solely of, or consists essentially of polymer layers.

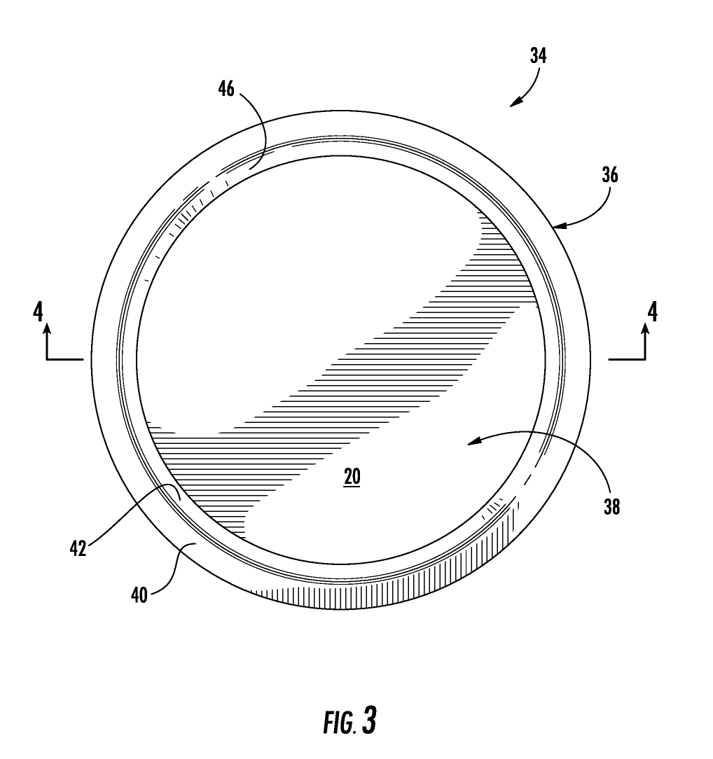

A wide variety of laminates, from which the blank 20 can be formed, are within the scope of this disclosure. That is, the blank 20/laminate 22 may include a variety of different layers (e.g., one or more layers of microwave energy interactive material 30) in a variety of different arrangements. For example, both of the polymer layers 24, 26 may be coated and/or extruded directly onto the substrate 28, or the polymer layers may be joined to the substrate through the use of adhesive material(s) (not shown) or in any other suitable conventional manner. By way of example, the layers of the laminate 22 may be joined using adhesive bonding, thermal bonding, or any other chemical or mechanical means. As additional examples, the bonding between the layers of the laminate 22 may be achieved using any suitable process, for example, spraying, roll coating, extrusion lamination, or any other process. As additional examples, one or both of the polymer layers 24, 26 may be a coextruded film. A variety of different types of coextrusions with differing numbers of layers and having layers with different characteristics are within the scope of this disclosure. For example, the various layers of the coextrusion can exhibit a wide variety of different properties such as, but not limited to, properties related to limiting oxygen and moisture transmission. Similarly, various markings (e.g., pictures and/or text) and/or colors can be incorporated into, or deposited on, the polymer layers 24, 26 or any other portion of the laminate 22, blank 20 (FIG. 1) or tray 34 (FIG. 3).

Optionally and as shown in FIG. 2, a microwave energy interactive material 30 (e.g., one or more microwave energy interactive materials) may be positioned between the substrate 28 and the upper polymer layer 24, and/or in any other (e.g., additional) suitable location. For example, a microwave energy interactive material may alternatively or also be positioned between the substrate 28 and the lower polymer layer 26.

The upper polymer layer 24 and the microwave energy interactive material 30 may be part of a microwave interactive web 32 that is secured to the substrate 28 by adhesive material (not shown) or in any other suitable conventional manner. The microwave interactive web 32 may include one or more layers of microwave energy interactive material 30 that are deposited onto or supported by the upper polymer layer 24. The microwave energy interactive material 30 may be incorporated in the laminate 22/blank 20 at any suitable location(s) to enhance or otherwise control the cooking (e.g., heating, browning, and/or crisping) of a food item (e.g., popcorn and oil) that is contained by a container (e.g., the tray 34 of FIG. 3) that is partially formed from the blank 20 and exposed to microwave energy. The microwave interactive web 32 may be, or may include, any type of suitable microwave energy interactive element or device, such as, but not limited to, a susceptor. As more specific examples, and not for purposes of limitation, the microwave interactive web 32 may comprise a continuously solid susceptor or a patterned susceptor. Referring to FIG. 1A, the stippling is schematically illustrative of the microwave energy interactive material 30. The optional microwave interactive web 32/microwave energy interactive material 30 is discussed in greater detail far below.

Typically any web 32/microwave energy interactive material 30 is part of the laminate 22 before the blank 20 is cut from the laminate, or the web 32/microwave energy interactive material 30 may be mounted to the blank 20 (e.g., as a “patch”) after the blank has been cut from the laminate 22 and before the blank is incorporated into the tray 34 (FIG. 3). Alternatively, the microwave interactive web 32/microwave energy interactive material 30 can be applied to or otherwise mounted to an already formed container (e.g., the tray 34 of FIG. 3). As a specific example, the microwave interactive web 32/microwave energy interactive material 30 can be mounted (e.g., by way of an adhesive material, heat seal coating or any other suitable means) to the interior surface(s) of the previously formed tray 34. In this regard, the entire disclosure of U.S. Patent Application Publication No. 2007/0215611 is incorporated herein by reference.

As alluded to above, the blank 20 is configured to form part of a container or other type of construct, such as the substantially round tray 34 shown in FIGS. 3-6. As best understood with reference to FIGS. 3-5, the tray 34 includes the substantially round blank 20 and a substantially round frame or body 36. The frame 36 is fixedly connected to the peripheral margin 20′ of the blank 20 in a manner so that, except for being upwardly open, an upper interior space 38 of the tray 34 is substantially leakproof/hermetically sealed. In the first embodiment, the blank 20 completely closes the bottom of the tray's upper interior space 38, and the frame 36 extends around and closes the sides of the tray's upper interior space, so that the tray's upper interior space is only upwardly open. Typically, the upper polymer layer 24 (FIG. 2) of the blank 20 is fluid impervious and in opposing face-to-face relation with lower region of the tray's upper interior space 38, and the frame 36 is fluid impervious and in opposing face-to-face relation with and extends around the side(s) of the tray's upper interior space. The frame 36 is typically constructed of polymeric material, such as, but not limited to, polyethylene terephthalate, that is fixedly injection-molded onto the periphery of the blank 20; however, the frame can also be constructed of other types of materials.

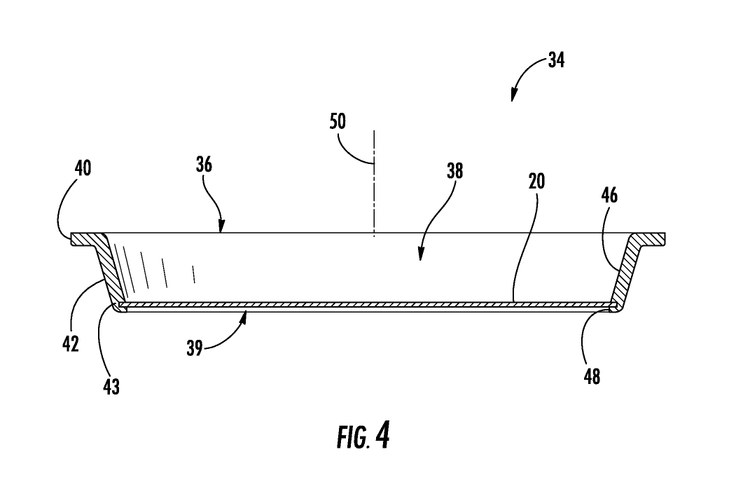

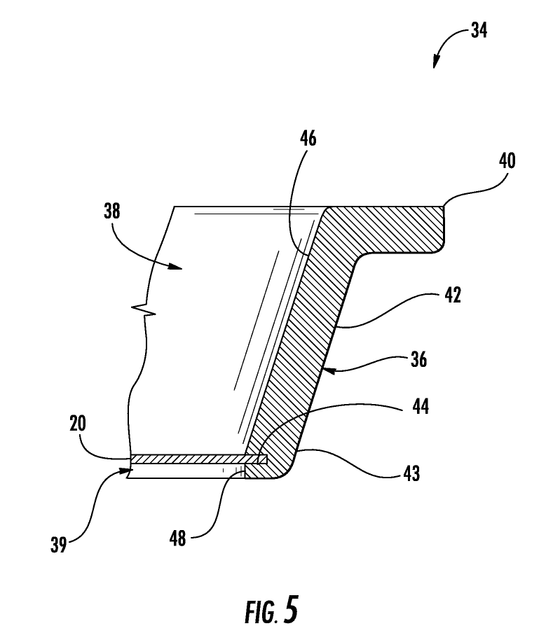

The tray 34 optionally further includes lower interior space 39 (see, e.g., FIGS. 4 and 5) that is typically much smaller than the upper interior space 38 and is typically (e.g., optionally) downwardly open. The lower interior space 39 may provide an insulating gap when, for example, the tray 34 is used in a microwave oven, as will be discussed in greater detail below. The blank 20 separates the upper and lower interior spaces 38, 39 from one another. In the first embodiment, the blank 20 completely closes the top of the tray's lower interior space 39, and the frame 36 extends around and closes the sides of the tray's lower interior space, so that the tray's lower interior space is only downwardly open. However and in one example, the lower interior space 39 may be laterally open (not shown), such as by way of indentations, groves or other passage-providing structures defined in the lower end of the sidewall 42 of the frame 36.

The frame 36 includes an outwardly projecting, annular rim 40, a sidewall 42 that is generally in the form of a truncated cone that extends downwardly and inwardly from the rim, and a base 43 at the lower end of the sidewall. The sidewall 42 includes an inner surface 46. An inner annular groove 44 is defined in the base 43. The groove 44 in the base 43 is fixedly in receipt of the peripheral margin 20′ of the blank 20. The groove 44 extends in a plane that is perpendicular to the upright, central axis 50 of the tray 34, and the groove substantially symmetrically encircles the central axis. The central axis 50 is schematically illustrated by a dashed line in FIG. 4. The upper inner surface 46 of the sidewall 42 extends upwardly from the groove 44 in the base 43. The upper inner surface 46 is substantially in the form of a truncated cone that extends downwardly and inwardly from the rim 40, so that the upper inner surface 46 substantially symmetrically encircles the central axis 50 and downwardly converges toward the central axis. The upper inner surface 46 of the sidewall 42 is in opposing face-to-face configuration with, and defines the lateral side(s) of, the upper interior space 38. A lower inner surface 48 of the base 43 extends downwardly from the groove 44. The lower inner surface 48 is substantially in the form of a cylinder that substantially symmetrically encircles and extends along the central axis 50. The lower inner surface 48 is in opposing face-to-face configuration with and defines the lateral side(s) of the lower interior space 39.

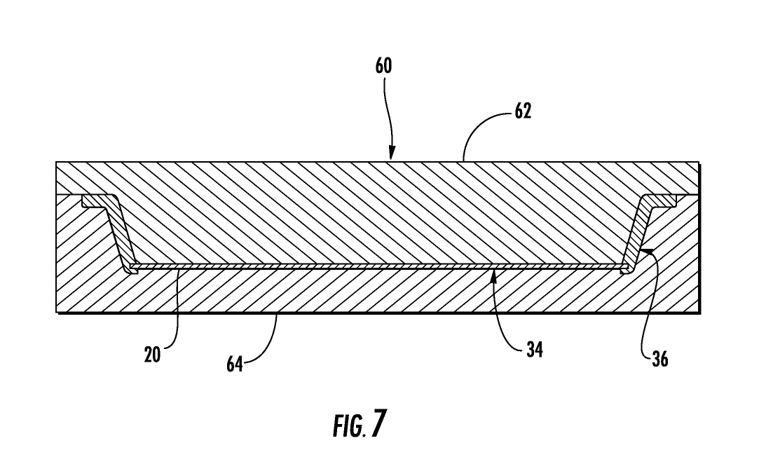

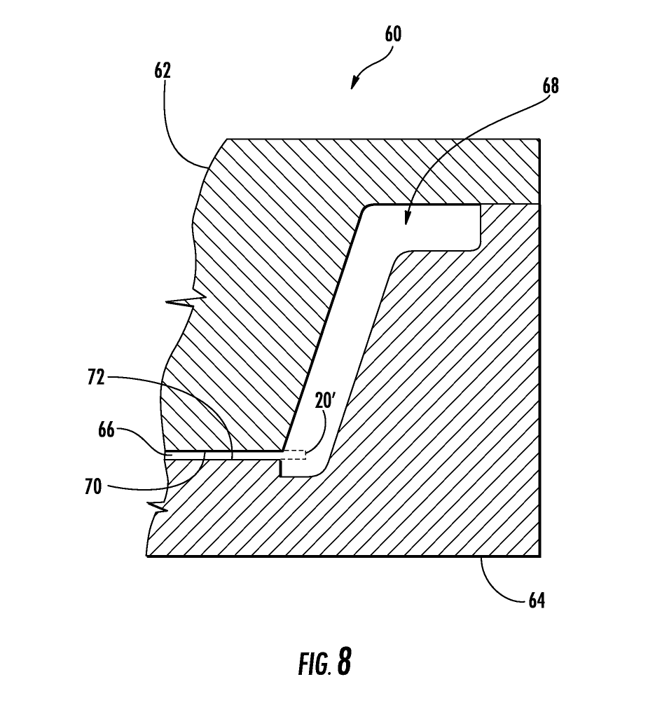

Alternatively, features of the tray 34 may be shaped differently than described above. For example, rather than the tray 34 being substantially round, in a top plan view the tray may be substantially polygonal (e.g., substantially rectangular) with rounded corners, in which case the above-described features described as being round, or the like, may be substantially polygonal (e.g., substantially rectangular). As another example, the frame's lower inner surface 48 may be in the form of a substantially truncated cone rather than being substantially in the form a cylinder. Nonetheless and in accordance with the first embodiment, the frame's lower inner surface 48 may be substantially in the form of cylinder (e.g., a slightly tapered cylinder) or in any other suitable shape for facilitating the injection-molding of the frame 36. An example of a method for manufacturing the tray 34 is discussed in the following, initially and primarily with reference to FIGS. 7 and 8, in accordance with the first embodiment. The frame 36 of the tray 34 is manufactured from molding material, namely polymeric material (e.g., polyethylene terephthalate), that is injected in liquid form into a closed mold assembly 60. FIG. 7 shows the tray 34 after it has been formed in the fully closed mold assembly 60. The mold assembly 60 includes a male mold 62 and a female mold 64, and there can be relative movement between the molds 62, 64 for opening and closing the mold assembly.

As best understood with reference to FIG. 8, the closed mold assembly 60 defines both a disklike cavity 66 and an annular cavity 68 that are defined between opposing faces of the male and female molds 62, 64. For example, the disklike cavity 66 is defined by and between a suspended circular face 70 of the male mold 62 and an elevated circular face 72 of the female mold 64. The faces 70, 72 are coaxially arranged (substantially coaxially arranged) with respect to one another and spaced apart from one another when the mold assembly 60 is in its closed configuration. The faces 70, 72 are in opposing face-to-face configuration with respect to one another when the mold assembly 60 is in its closed configuration and the disklike cavity 66 is empty.

The disklike cavity 66 is configured for receiving the central portion of the blank 20. Accordingly, the suspended face 70 of the male mold 62 and the elevated face 72 of the female mold 64 may be respectively referred to as first and second blank receiving faces in some embodiments. As an initial step of forming the tray 34, the flat blank 20 (the peripheral margin 20′ of which is shown by dashed lines in FIG. 8) may be placed coaxially upon (substantially coaxially upon) the face 72 of the female mold 64 of the open mold assembly 60. If desired, the blank 20 may be held in this proper placement by virtue of suction being supplied to one or more vacuum cups (not shown) in the face 72 of the female mold 64, or by way of any other suitable device(s).

While the blank 20 is properly positioned upon the face 72 of the female mold 64, the male mold 62 may be advanced toward the stationary female mold under the action of a hydraulic press (not shown), or the like. Alternatively, the female mold 64 may be moved toward the male mold 62, and/or the flat blank 20 may initially be placed coaxially upon the face 70 of the male mold 62 of the open mold assembly 60. Irrespective, the blank 20 is coaxially (substantially coaxially) pinched between the faces 70, 72 of the molds 62, 64 when the mold assembly 60 is closed. More specifically, the disklike cavity 66 is configured for receiving the central portion of the blank 20 so that, when the mold assembly 60 is fully closed, the lower, central face 70 of the male mold 62 is in firm, opposing face-to-face contact with the upper central portion of the blank, and the inner, central face 72 of the female mold 64 is in firm, opposing face-to-face contact with the lower central portion of the blank, in a manner that seeks to prevent (e.g., in a manner that substantially prevents) the molding material from entering the disklike cavity 66.

The male mold 62 and the female mold 64 are typically configured to avoid (e.g., substantially avoid) contact with the peripheral margin 20′ of the blank. In this regard, the annular cavity 68 of the closed mold assembly 60 is configured for receiving both the peripheral margin 20′ of the blank 20 and the molding material. For example, the peripheral margin 20′ of the blank 20 is schematically illustrated by dashed lines in FIG. 8. As shown in FIGS. 5 and 8, the peripheral margin 20′ of the blank 20 extends about half way into the thickness of the sidewall 42 (FIG. 5) of the frame 36. When the mold assembly 60 is fully closed, the annular cavity 68 is fully closed, except that the liquid molding material may be injected into the annular cavity by way of one or more passageways (e.g., gate(s)). Whereas the mold assembly 60 is shown in a particular orientation in the figures herewith, it may be in any suitable orientation (e.g., it may be inverted). In this regard, it should be understood that reference to “top” and “bottom” portions of the tray 34 and the mold assembly 60 generally refer to the orientation shown in the figures, but the mold assembly may be reoriented as may be understood.

In accordance with the first embodiment, the liquid molding material is injected by way of one or more passageways (e.g., via gate(s)) into the annular cavity 68 and flows within the annular cavity in a manner that seeks to maintain (e.g., in a manner that substantially maintains) the peripheral margin 20′ of the blank 20 in a substantially planar configuration with the pinched central portion of the blank, so that the peripheral margin of the blank is substantially hermetically sealed into the groove 44 of the frame 36. Alternatively, the peripheral margin 20′ of the blank 20 may be bent by the injected liquid molding material, so long as the peripheral margin of the blank is substantially hermetically sealed into the groove 44, or the like, of the frame 36. Alternatively, in some situations it may be optional to have the peripheral margin 20′ of the blank 20 substantially hermetically sealed into the groove 44 of the frame 36 (e.g., the peripheral margin of the blank 20 may be attached to the sidewall 42, such as by extending into the groove 44, without there being a hermetic seal therebetween).

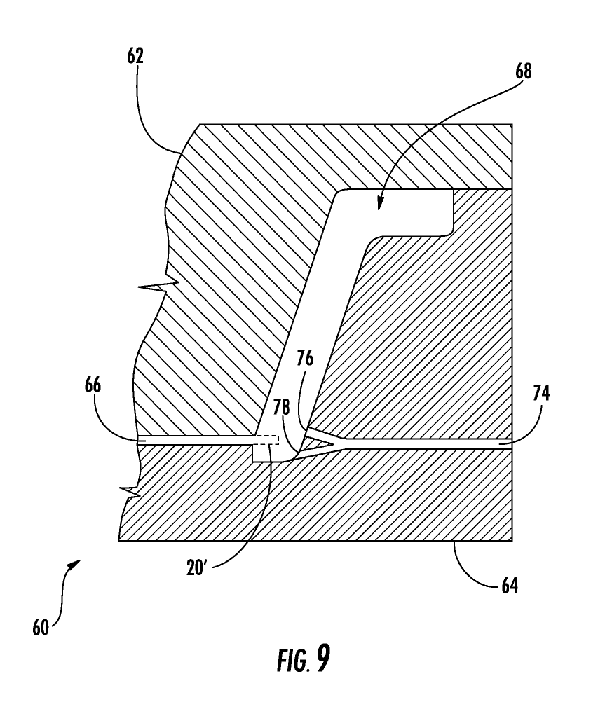

FIG. 9 illustrates a first example of a possible arrangement of passageways that may be used for injecting liquid molding material into the annular cavity 68 of the mold assembly 60. FIG. 9 shows one embodiment in which the mold assembly 60 includes a single upstream passageway 74 (e.g., a gate) connected to two injection ports, namely upper and lower flow channels or ports 76, 78 (e.g., gates). Each of the passageway 74 and the ports 76, 78 is positioned in the female mold 64. The upper and lower ports 76, 78 are positioned above and below the peripheral margin 20′ of the blank 20 for directing the molding material respectively to the top and bottom surfaces of the blank's peripheral margin. It is believed that all of the molding material for forming the frame 36 may be supplied by way of the single upstream passageway 74 to the upper and lower ports 76, 78. The molding material may enter the annular cavity 68 solely from the two ports 76, 78, and flow within and around the annular cavity to fill the annular cavity. Alternatively, there may be numerous of the passageways 74 and ports 76, 78 in a single female mold 64.

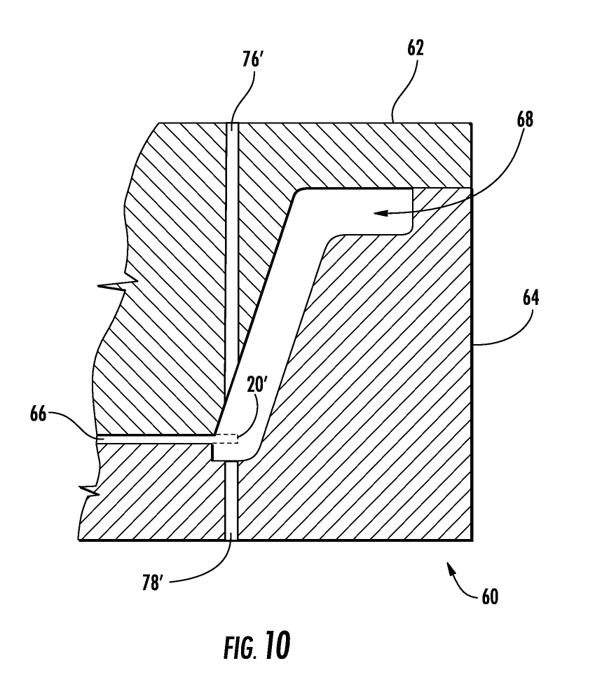

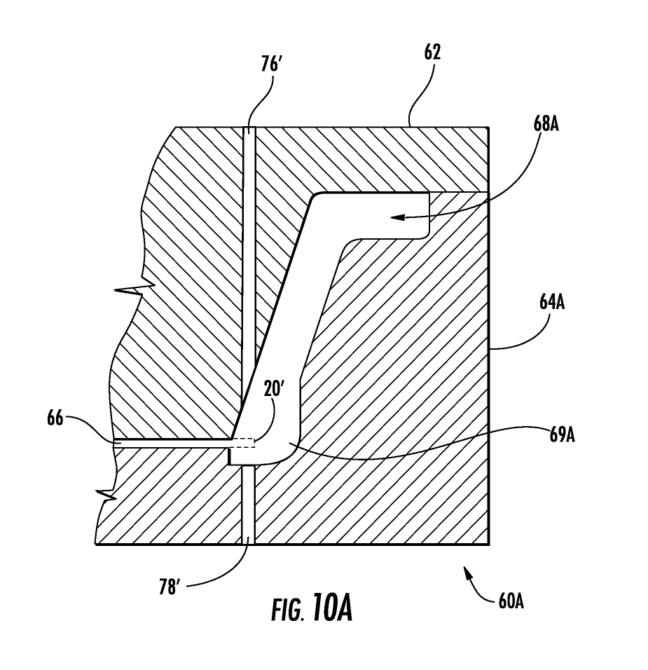

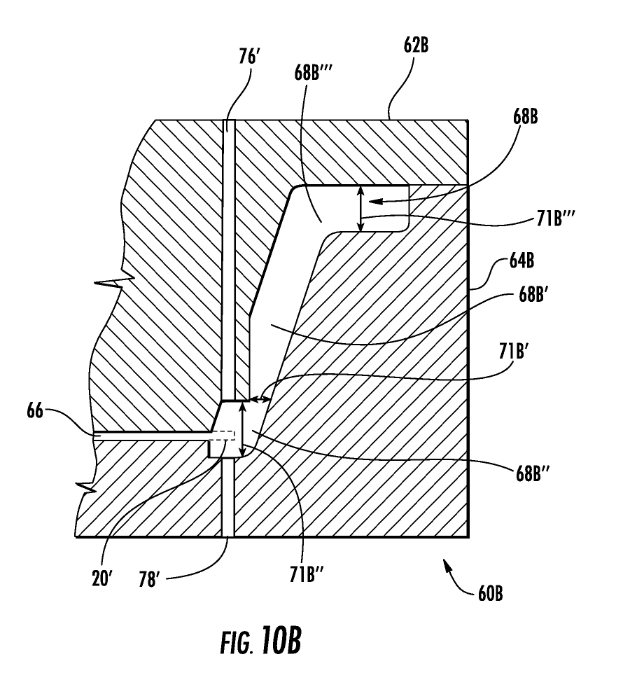

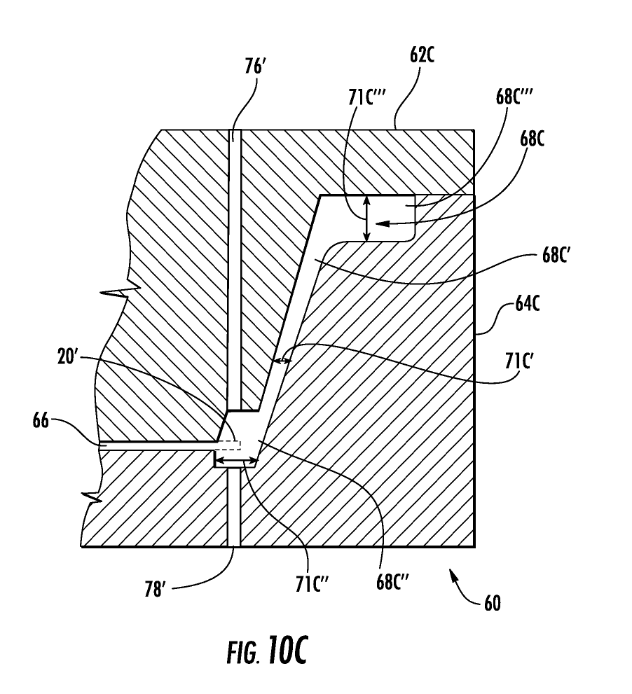

FIG. 10 illustrates a second example of a possible arrangement of passageways that may be used for injecting molding material into the annular cavity 68 of the mold assembly 60. FIG. 10 shows that in one embodiment the mold assembly 60 includes solely two injection ports, namely upper and lower flow channels or ports 76′, 78′ (e.g., gates) that are respectively located in the male and female molds 62, 64. The upper and lower ports 76′, 78′ are positioned above and below the peripheral margin 20′ of the blank 20 for directing the molding material to the top and bottom surfaces of the blank, respectively. It is believed that all of the molding material for forming the frame 36 may be supplied by way of the upper and lower ports 76′, 78′. The molding material may enter the annular cavity 68 solely from the ports 76′, 78′, and flow within and around the annular cavity to fill the annular cavity. Alternatively, there may be numerous of the ports 76′, 78′ in a single mold assembly 60.

In accordance with the above-described examples of the first embodiment, it is believed that the upper and lower ports 76, 76′, 78, 78′ may be sized, arranged and/or operated in a manner that seeks to maintain (e.g., in a manner that substantially maintains) the peripheral margin 20′ of the blank 20 in a substantially planar configuration with the central portion of the blank, so that the peripheral margin of the blank is substantially hermetically sealed into the groove 44 of the frame 36. For example, in FIG. 9 the passageway 74 is substantially coplanar with a plane defined by the major surface of the blank 20 (e.g., a top or bottom surface of the blank), but the ports 76, 78 are configured to define a non-zero angle with respect to the plane defined by the major surface of the blank. Thereby, direct impingement of the liquid molding material on the peripheral edge 20′ of the blank may be avoided. Further, FIG. 10 illustrates an embodiment in which the ports 76′, 78′ and the passageways supplying the liquid molding material thereto define non-zero angles with respect to a plane defined by a major surface of the blank 20. In this embodiment, flow of liquid molding material may be directed at the peripheral edge 20′, but in a manner that is balanced by supplying the liquid molding material on opposing sides thereof.

By way of further example of features configured to maintain the peripheral edge of the blank in a planar configuration, one of ordinary skill in the molding art will understand that a gate may be controlled thermally (e.g., by way of thermal gating technology) and/or with a valve (by way of valve gate technology). Accordingly and in one possible implementation, flow through one or more of the ports 76, 76′, 78, 78′ may be controlled in a manner that seeks to maintain (e.g., in a manner that substantially maintains) the peripheral margin 20′ of the blank 20 in a substantially planar configuration with the central portion of the blank, so that the periphery of the blank is substantially hermetically sealed into the groove 44 of the frame 36. For example, it is believed that the pressure and/or volume and/or duration of the injecting by way of the lower ports 78, 78′ may be adjusted relative to the pressure and/or volume and/or duration of the injecting by way of the upper ports 76, 76′ and/or vice versa, in a manner that seeks to maintain (e.g., in a manner that substantially maintains) the of the blank 20 in a substantially planar configuration with the central portion of the blank, so that the periphery of the blank is substantially hermetically sealed into the groove 44 of the frame 36. As a more specific example, it is believed that the injection of the liquid molding material by way of the lower ports 78, 78′ may be terminated after the peripheral margin 20′ of the blank 20 is securely encapsulated by the molding material but before the injection of the liquid molding material by way of the upper port 76 is terminated.

With further regard to methods and features configured to maintain the peripheral margin 20′ of the of the blank 20 in a substantially planar configuration relative to the remainder of the blank, in some embodiments the pressure exerted on the peripheral margin 20′ of the blank 20 by the liquid molding material may be controlled by selecting the cross-sectional area of the annular cavity 68 or other portion of the mold assembly 60 proximate the peripheral margin of the blank to achieve a desired pressure. For example, FIG. 10A illustrates an embodiment of the mold assembly 60A that may be substantially the same as the mold assemblies discussed above (e.g., the mold assembly 60 of FIG. 10), except a cutout portion 69A is removed from the female blank 64A. The cutout portion 69A may be configured to increase the cross-sectional area of the annular cavity 68A proximate the blank 20 such that the force exerted on the peripheral margin 20′ of the blank caused by the liquid molding material is reduced or equalized across the top and bottom thereof. In some embodiments the cross-sectional area of the annular cavity 68A may be configured to be equal on both sides of the blank 20 (e.g., upper and lower sides). However, in other embodiments the mold assembly 60 may be configured to define a greater cross-sectional area on one side of the blank 20 than on the other side of the blank. Accordingly, a differential in force caused by the pressure of the injection molding material may be employed to compensate for other forces on the peripheral margin 20′ of the blank 20 (e.g., gravity) in some embodiments.

In another embodiment, for example as shown in FIG. 10B, a mold assembly 60B may be substantially similar to other mold assemblies disclosed herein (e.g., the mold assembly 60 of FIG. 10), except the annular cavity 68B may define a sidewall portion 68B′ with a minimum cross-sectional dimension 71B′ that is configured to be less than minimum cross-sectional dimensions 71B″, 71B′″ of a base portion 68B″ and a rim portion 68B′″ of the annular cavity. In this regard, the male mold 62B of the mold assembly 60B may project into the annular cavity 68B such that the sidewall portion 68B′ includes a relatively smaller minimum cross-sectional dimension 71B′, as compared to other portions of the annular cavity. However, in other embodiments the female mold may additionally or alternatively be configured to reduce a minimum cross-sectional dimension of the sidewall portion. For example, FIG. 10C illustrates an embodiment of a mold assembly 60C that may be similar to other embodiments of the mold assemblies disclosed herein (e.g., the mold assembly 60 of FIG. 10), except the annular cavity 68C may define a sidewall portion 68C′ with a minimum cross-sectional dimension 71C′ that is configured to be less than minimum cross-sectional dimensions 71C″, 71C′″ of a base portion 68C″ and a rim portion 68C′″ due to the male mold 62C and the female mold 64C extending relatively closer to one another in the closed configuration.

By defining a sidewall portion 68B′, 68C′ of the annular cavity 68B, 68C with a relatively smaller cross-sectional dimension 71B′, 71C′, the liquid molding material may be substantially confined in the base portion 68B″, 68C″ prior to the liquid molding material entering the sidewall portion and the rim portion 68B″, 68C″. In this regard, by defining a constriction in the sidewall portion 68B′, 68C′ of the annular cavity 68B, 68C, the liquid molding material may substantially entirely fill the base portion 68B″, 68C″ prior to traveling into the sidewall portion. Conversely, adding a cutout portion 69A configured to increase the cross-sectional area of the annular cavity 68A proximate the blank 20 may provide similar functionality. As may be understood, the annular cavities shown in FIGS. 10A-C may substantially correspond to the shapes of the bodies of the constructs formed from the illustrated mold assemblies. Thus, in some embodiments the sidewalls of the bodies of the constructs may define a minimum cross-sectional dimension (e.g., a thickness) that is less than that of the base and/or rim of the body.

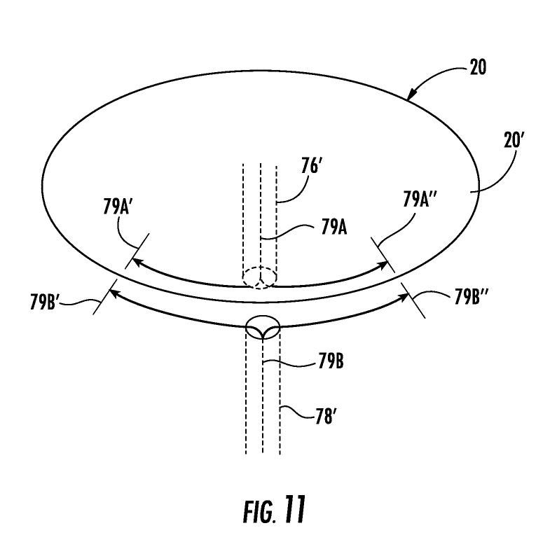

By filling the annular cavity proximate to the blank with liquid molding material prior to filling the remainder thereof, the forces on the blank may be balanced such that the blank retains a substantially planar configuration. In this regard, the features described above (including controlling the pressure, volume, and/or duration of the liquid molding material injected through the lower ports 78, 78′ relative to (e.g., independently therefrom) the liquid molding material injected through the upper ports 76, 76′, and/or providing the annular cavity 68 with a relatively larger cross-sectional dimension proximate the blank 20 relative to a remainder thereof (e.g., as illustrated in FIGS. 10A-C) may be configured to encourage the flow of the liquid molding material to travel around the peripheral margin 20′ of the blank at substantially the same pace. For example, FIG. 11 schematically illustrates a first flow 79A of the liquid molding material out of the upper port 76′ and a second flow 79B of the liquid molding material out of the lower port 78′ of a mold assembly (not shown for clarity purposes). As illustrated, the first flow 79A and the second flow extend around the peripheral margin 20′ on opposing sides (e.g., top and bottom sides) of the blank 20. As further illustrated, the first flow 79A may extend to first flow fronts 79A′, 79A″ that substantially align with second flow fronts 79B′, 79B″ of the second flow 79B as the liquid molding material fills the annular cavity 68. Accordingly, by substantially equalizing the location (e.g., the angular position) of the first flow fronts 79A′, 79A″ with the location of the second flow fronts 79B′, 79B″ on opposing sides of the peripheral margin 20′ of the blank 20 while the liquid molding material fills the annular cavity 68, substantially equal opposing forces on the blank may balance one another such that the blank maintains a substantially unbiased (e.g., planar) configuration. Accordingly, improved sealing between the blank and body formed from the liquid molding material may be improved, as discussed above.

Alternatively, the passageway(s) (e.g., gate(s)) for injecting molding material into the annular cavity 68 may be positioned and/or operated differently than described above. For example, the peripheral margin 20′ of the blank 20 may be sufficiently rigid so that the rigidity of the blank seeks to maintain (e.g., substantially maintains) the periphery of the blank in a substantially planar configuration with the central portion of the blank, so that the peripheral margin of the blank is substantially hermetically sealed into the groove 44 of the frame 36. Alternatively, the peripheral edge of the blank may define any suitable configuration (e.g., an irregular, wavy, and/or undulating configuration) that may equalize any pressure differential and/or otherwise control the pressures on the peripheral edge of the blank as discussed above. Further, an irregular, wavy, and/or undulating configuration may allow flow of the liquid molding material between top and bottom portions thereof, which may substantially equalize the flow fronts on the top and bottom portions of the peripheral edge of the blank.

In one example, the microwave energy interactive material 30 may comprise a susceptor for enhancing the heating, browning, and/or crisping of the food item. A susceptor is a thin layer of microwave energy interactive material, for example, aluminum, generally less than about 500 angstroms in thickness, for example, from about 60 to about 100 angstroms in thickness, and having an optical density of from about 0.15 to about 0.35, for example, about 0.17 to about 0.28. When exposed to microwave energy, the susceptor tends to absorb at least a portion of the microwave energy and convert it to thermal energy (i.e., heat) through resistive losses in the layer of microwave energy interactive material. The remaining microwave energy is either reflected by or transmitted through the susceptor. However, other microwave energy interactive elements may be used, as will be discussed further below.

In one example, the liquid molding material may be a polymer that is injected into the annular cavity 68 of the closed mold assembly 60, and it is believed that the injected polymer may be at a temperature of about 500 degrees Fahrenheit and a pressure of approximately 2000 lb/in². The injection temperature and pressure may depend upon the polymer that is injected, and a wide variety of polymers, temperatures and pressures are within the scope of this disclosure. For example and not for the purpose of limiting the scope of this disclosure, suitable polymers for being injected may be polypropylene, nylon and/or polyethylene terephthalate. In one example, it is thought that the liquid molding material may be polypropylene that is injected into the annular cavity 68 of the closed mold assembly 60, with the injected polypropylene being at a temperature of about 450 degrees Fahrenheit and a pressure of approximately 1750 lb/in². The polymeric liquid molding material that is injected into the annular cavity 68 of the closed mold assembly 60 may include one or more additives, such as short glass fibers. Impregnating the polymeric liquid molding material with short glass fibers can help to advantageously control/minimize shrinkage of the solidifying polymeric material. The polymeric liquid molding material may include about 30% glass fibers by weight, although other amounts and other additives are also within the scope of this disclosure.

After the liquid molding material solidifies so that the tray 34 is formed within the mold assembly 60, the mold assembly is opened and the tray 34 can be removed. Thereafter, the mold assembly 60 can be used to manufacture another tray 34.

In accordance with the above-described examples of the first embodiment, the polymer layers 24, 26 of the laminate 22/blank 20 and the molding material (e.g., polymeric material) from which the frame 36 are constructed are selected to be compatible, so that there is good adhesion between the frame 36 and the polymer layers 24, 26 of the blank 20. In one example, both the frame 36 and the polymer layers 24, 26 are a polyolefin, such as polypropylene. As another example, each of the frame 36 and the polymer layers 24, 26 can be nylon or polyethylene terephthalate. A wide variety of other polymers can also be used. When the polymer layers 24, 26 are coextrusions, it is the outer-most layer of the polymer layers 24, 26 that is selected to be compatible with the frame 36 so that there is good adhesion therebetween. In an alternative embodiment of this disclosure, such as where the materials are selected so that there is less adhesion between them (i.e., less adhesion between the frame 36 and the blank 20), the blank or portions thereof (e.g., the peripheral margin 20′ of the blank) can be at least partially embedded in, or encapsulated by, the frame in a manner such that the blank and the frame are nonetheless fixedly attached to one another, if desired.

After the tray 34 is formed, food (not shown) can be placed in the tray's upper interior space 38, and then the tray's upper interior space can optionally be closed in a leakproof manner, such as with a cover (not shown) in the form of a polymeric overwrap (e.g., polymer film). For example, the cover may be sealed (e.g., heat sealed) to the flat upper surface of the rim 40. Alternatively, the tray 34 can be closed with lids made of paperboard, foil or any other suitable material. A variety of mechanisms for closing the upper opening of the tray 34, such as in a leakproof manner, are within the scope of this disclosure.

As one acceptable method of use, food within the tray 34 may be heated in a microwave oven (not shown). The lower interior space 39 of the tray 34 may advantageously provide an insulating gap between the blank 20 of the tray 34 and the floor or turntable of the microwave oven. This insulating gap seeks to keep heat energy from being disadvantageously transferred away from the blank 20 and/or the food within the tray's upper interior space 38 to the floor or turntable of the microwave oven, or to any other surface. In addition, microwave energy may be able to propagate through the lower interior space 39 of the tray 34 to advantageously reach the blank 20 from below.

As mentioned above, a variety of differently shaped trays are within the scope of this disclosure. Similarly, a variety of differently sized trays are within the scope of this disclosure. For example and without limitation, FIG. 12 shows an embodiment of a tray 34′ that includes a different placement of the blank 20 relative to a frame 36′ in accordance with a second embodiment of this disclosure. The second embodiment may be like the first embodiment, except the blank 20 may be positioned such that a relatively larger lower interior space 39′ is provided. In this regard, a larger gap may exist relative to a surface on which the tray 34′ is positioned such that improved insulation properties may be provided with respect to the surface. As further illustrated in FIG. 12, the tray 34′ may incorporate features configured to simplify manufacturing of the tray. In this regard, the base 43′ of the tray 34′ may define a lower inner surface 48′ that is configured to be vertical or substantially vertical, when the tray is oriented as shown. Alternatively, the inner surface 48′ may define an angle with respect to vertical (in terms of the orientation shown) whereby the inner surface 48′ slopes toward an outer surface 52′ of the base 43′.

Accordingly, by either configuring the sidewall 42′such that the lower inner surface 48′ extends substantially vertically or angles toward the outer surface 52′ of the base 43′, manufacturing of the tray 34′ may be simplified. For example, the tray 34′ may not define any undercut surfaces when manufactured as shown. In this regard, if the sidewall 42′ and base 43′ were to extend in a substantially continuous manner to a lower end 43A′, an undercut portion 54′ would be created. This undercut portion 54′ may cause an interference fit relationship to be established with a mold assembly employed to create the tray 34′, which could prevent removal of the tray 34′ from the mold assembly. Accordingly, a mold assembly may be configured to cause the sidewall 42′ and base 43′ to not include any undercut portions such as the undercut portion 54′ illustrated in the lower interior space 39′ of the tray 34′. In this regard, the mold assembly may substantially mimic the shape shown in FIG. 12 and/or include features configured to avoid overlapping relationships between the tray and the mold assembly that could cause an interference fit whereby the tray and mold bind to one-another as described above. The first embodiment of the tray 34 and the mold assembly 60 configured to create the first embodiment of the tray may be similarly configured so as to avoid overlapping relationships (e.g., the above-described undercut) that could potentially bind the tray to the mold.

As mentioned above, the tray 34 is one example of a construct (e.g., container) of this disclosure. As alluded to above, any of the various constructs of this disclosure may optionally include one or more features that alter the effect of microwave energy during the heating or cooking of a food item that is associated with the construct. For example, the construct may be formed at least partially from (e.g., the web 32 and/or layer of microwave energy interactive material 30 shown in FIG. 2 can include) one or more microwave energy interactive elements (hereinafter sometimes referred to as “microwave interactive elements”) that promote heating, browning and/or crisping of a particular area of the food item, shield a particular area of the food item from microwave energy to prevent overcooking thereof, or transmit microwave energy towards or away from a particular area of the food item. Each microwave interactive element comprises one or more microwave energy interactive materials or segments arranged in a particular configuration to absorb microwave energy, transmit microwave energy, reflect microwave energy, or direct microwave energy, as needed or desired for a particular construct and food item.

In the case of a susceptor, the microwave energy interactive material may comprise an electroconductive or semiconductive material, for example, a vacuum deposited metal or metal alloy, or a metallic ink, an organic ink, an inorganic ink, a metallic paste, an organic paste, an inorganic paste, or any combination thereof Examples of metals and metal alloys that may be suitable include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof

Alternatively, the microwave energy interactive material may comprise a metal oxide, for example, oxides of aluminum, iron, and tin, optionally used in conjunction with an electrically conductive material. Another metal oxide that may be suitable is indium tin oxide (ITO). ITO has a relatively more uniform crystal structure and, therefore, is clear at most coating thicknesses.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

In other embodiments, the microwave energy interactive material may be carbon-based, for example, as disclosed in U.S. Pat. Nos. 4,943,456, 5,002,826, 5,118,747, and 5,410,135.

In still other embodiments, the microwave energy interactive material may interact with the magnetic portion of the electromagnetic energy in the microwave oven. Correctly chosen materials of this type can self-limit based on the loss of interaction when the Curie temperature of the material is reached. An example of such an interactive coating is described in U.S. Pat. No. 4,283,427.

The use of other microwave energy interactive elements is also contemplated. In one example, the microwave energy interactive element may comprise a foil or high optical density evaporated material having a thickness sufficient to reflect a substantial portion of impinging microwave energy. Such elements typically are formed from a conductive, reflective metal or metal alloy, for example, aluminum, copper, or stainless steel, in the form of a solid “patch” generally having a thickness of from about 0.000285 inches to about 0.005 inches, for example, from about 0.0003 inches to about 0.003 inches. Other such elements may have a thickness of from about 0.00035 inches to about 0.002 inches, for example, 0.0016 inches.

In some cases, microwave energy reflecting (or reflective) elements may be used as shielding elements where the food item is prone to scorching or drying out during heating. In other cases, smaller microwave energy reflecting elements may be used to diffuse or lessen the intensity of microwave energy. One example of a material utilizing such microwave energy reflecting elements is commercially available from Graphic Packaging International, Inc. (Marietta, Ga.) as MICRORITE® packaging material. In other examples, a plurality of microwave energy reflecting elements may be arranged to form a microwave energy distributing element to direct microwave energy to specific areas of the food item. If desired, the loops may be of a length that causes microwave energy to resonate, thereby enhancing the distribution effect. Microwave energy distributing elements are described in U.S. Pat. Nos. 6,204,492, 6,433,322, 6,552,315, and 6,677,563, each of which is incorporated by reference in its entirety.

If desired, any of the numerous microwave energy interactive elements described herein or contemplated hereby may be substantially continuous, that is, without substantial breaks or interruptions, or may be discontinuous, for example, by including one or more breaks or apertures that transmit microwave energy. The breaks or apertures may extend through the entire structure, or only through one or more layers. The number, shape, size, and positioning of such breaks or apertures may vary for a particular application depending on the type of construct being formed, the food item to be heated therein or thereon, the desired degree of heating, browning, and/or crisping, whether direct exposure to microwave energy is needed or desired to attain uniform heating of the food item, the need for regulating the change in temperature of the food item through direct heating, and whether and to what extent there is a need for venting.

By way of illustration, a microwave energy interactive element may include one or more transparent areas to effect dielectric heating of the food item. However, where the microwave energy interactive element comprises a susceptor, such apertures decrease the total microwave energy interactive area, and therefore, decrease the amount of microwave energy interactive material available for heating, browning, and/or crisping the surface of the food item. Thus, the relative amounts of microwave energy interactive areas and microwave energy transparent areas must be balanced to attain the desired overall heating characteristics for the particular food item.

As another example, one or more portions of a susceptor may be designed to be microwave energy inactive to ensure that the microwave energy is focused efficiently on the areas to be heated, browned, and/or crisped, rather than being lost to portions of the food item not intended to be browned and/or crisped or to the heating environment. Additionally or alternatively, it may be beneficial to create one or more discontinuities or inactive regions to prevent overheating or charring of the food item and/or the construct including the susceptor.

As still another example, a susceptor may incorporate one or more “fuse” elements that limit the propagation of cracks in the susceptor, and thereby control overheating, in areas of the susceptor where heat transfer to the food is low and the susceptor might tend to become too hot. The size and shape of the fuses may be varied as needed. Examples of susceptors including such fuses are provided, for example, in U.S. Pat. No. 5,412,187, U.S. Pat. No. 5,530,231, U.S. Patent Application Publication No. US 2008/0035634A1, published Feb. 14, 2008, and PCT Application Publication No. WO 2007/127371, published Nov. 8, 2007, each of which is incorporated by reference herein in its entirety.

It will be noted that any of such discontinuities or apertures in a susceptor may comprise a physical aperture or void in one or more layers or materials used to form the structure or construct, or may be a non-physical “aperture”. A non-physical aperture is a microwave energy transparent area that allows microwave energy to pass through the structure without an actual void or hole cut through the structure. Such areas may be formed by simply not applying microwave energy interactive material to the particular area, by removing microwave energy interactive material from the particular area, or by mechanically deactivating the particular area (rendering the area electrically discontinuous). Alternatively, the areas may be formed by chemically deactivating the microwave energy interactive material in the particular area, thereby transforming the microwave energy interactive material in the area into a substance that is transparent to microwave energy (i.e., microwave energy inactive). While both physical and non-physical apertures allow the food item to be heated directly by the microwave energy, a physical aperture also provides a venting function to allow steam or other vapors or liquid released from the food item to be carried away from the food item.

As noted above in the description relating to FIG. 1A, the material composition and/or material properties of the blank 20 may vary at various portions thereof. For example, in FIG. 1A, the material composition and/or material properties of the blank 20 are illustrated as being different at the peripheral margin 20′ than at the remaining portion 20″ thereof. In this regard, as described above, the peripheral margin 20′ of the blank 20 may be coupled to the frame 36, and hence it may be desirable for the peripheral margin to define different material properties than the remaining portion 20″. As further discussed above, in some embodiments the tray 34 may be used in applications whereby the tray is heated, for example, in a microwave oven. It may be desirable to avoid unnecessarily heating the frame 36 and/or other portions of the tray 34. In this regard, the peripheral margin 20′ of the blank 20 may in some embodiments not include a susceptor or other microwave energy interactive material. In other embodiments the susceptor or other microwave energy interactive material may be deactivated, for example through chemical deactivation, whereby the material's interaction with microwaves is reduced or eliminated such that less heat or no heat is produced by interactions with the microwaves. By chemically deactivating the microwave energy interactive material in a particular area (e.g., the peripheral edge of the blank), the microwave energy interactive material in that area may be transformed into a substance that is transparent to microwave energy (i.e., microwave energy inactive). Thereby, the peripheral margin 20′ of the blank 20 may avoid unnecessarily heating the frame 36.

Further, by avoiding heating the peripheral margin 20′ of the blank 20, issues with respect to different rates of expansion may be reduced by decreasing the amount of heat received at the joint between the blank and frame 36, which may otherwise potentially harm the structural integrity of the joint therebetween. However, various other or additional differences in the material composition or material properties of the blank at the peripheral margin or other portions thereof may exist. For example, the peripheral margin may include a component configured to improve bonding between the blank and the frame.

Numerous other possibilities are contemplated.

Directional references (e.g., upper, lower, upward, downward, left, right, leftward, rightward, top, bottom, above, below, vertical, horizontal, clockwise, and counterclockwise) have been used in this disclosure for ease of understanding and not for the purpose of limiting the scope of this disclosure. Also, in considering the scope of this disclosure, each of the features of this disclosure should be considered in isolation, and in various combinations and subcombinations.

It will be understood by those skilled in the art that while the present disclosure has been discussed above with reference to exemplary embodiments, various additions, modifications and changes can be made thereto without departing from the spirit and scope of the invention as set forth in the claims.

What is claimed is:

1. A construct comprising:
a blank having a first surface and a second surface configured in an opposing relationship, the first surface and the second surface extending to a peripheral margin of the blank; and
an injection-molded body comprising:
a rim;
a base defining an inner groove engaged with the peripheral margin of the blank; and
a sidewall that substantially continuously extends from the base to the rim around a periphery of the injection-molded body.

2. The construct of claim 1, wherein a peripheral margin of the blank has a material composition that varies from a material composition of the remaining portion of the blank.

3. The construct of claim 2, wherein the blank includes a microwave energy interactive material except at the peripheral margin.

4. The construct of claim 2, wherein the blank includes a microwave energy interactive material, and wherein the microwave interactive material is deactivated at the peripheral margin.

5. The construct of claim 1, wherein a thickness of the sidewall is less than a thickness of the base.

6. The construct of claim 1, wherein a thickness of the sidewall is less than a thickness of the rim.

7. A mold assembly comprising:
a male mold defining a first blank receiving face and an outer face;
a female mold defining a second blank receiving face and an inner face,
wherein the male mold and the female mold are configured to cooperatively define:
a first cavity defined between the inner face of the female mold and the outer face of the male mold and configured to receive a peripheral margin of a blank, and
a second cavity defined between the first blank receiving face of the male mold and the second blank receiving face of the female mold and configured to receive a remaining portion of the blank; and
at least one passageway configured to direct a liquid molding material through two or more ports into the first cavity,
wherein the ports are configured to be positioned on opposing sides of the peripheral margin of the blank.

8. The mold assembly of claim 7, wherein the passageway and the ports are defined in the female mold.

9. The mold assembly of claim 7, wherein the passageway is configured to define a non-zero angle with respect to a plane defined by a major surface of the blank.

10. The mold assembly of claim 9, wherein the ports are configured to define a non-zero angle with respect to the plane defined by the major surface of the blank.

11. The mold assembly of claim 7, wherein the ports are configured to define a non-zero angle with respect to a plane defined by a major surface of the blank.

12. The mold assembly of claim 11, wherein the passageway is configured to be substantially coplanar with the major surface of the blank.

13. The mold assembly of claim 7, wherein the female mold defines a cutout portion configured to define an increased cross-sectional area in the first cavity proximate the peripheral margin of the blank.

14. The mold assembly of claim 7, wherein the at least one passageway comprises a first passageway defined in the male mold and a second passageway defined in the female mold.

15. The mold assembly of claim 7, wherein the male mold and the female mold are configured to pinch the remaining portion of the blank between the first blank receiving face and the second blank receiving face.

16. The mold assembly of claim 15, wherein the male mold and the female mold are configured to avoid contact with the peripheral margin of the blank.

17. The mold assembly of claim 7, wherein the first cavity defines a base portion, a sidewall portion and a rim portion, wherein a minimum cross-sectional dimension of the sidewall portion is less than a minimum cross-sectional dimension of the base portion and a minimum cross-sectional dimension of the rim portion.

18. A method for forming a construct, comprising:
having a mold assembly comprising:
a male mold defining a first blank receiving face and an outer face, and
a female mold defining a second blank receiving face and an inner face;
inserting a blank into the mold assembly such that a peripheral margin of the blank is received in a first cavity defined between the inner face of the female mold and the outer face of the male mold and a remaining portion of the blank is received in a second cavity defined between the first blank receiving face of the male mold and the second blank receiving face of the female mold; and
directing a liquid molding material through at least one passageway and out of two or more ports defined in the mold assembly into the first cavity on opposing sides of the peripheral margin of the blank.

19. The method of claim 18 further comprising deactivating one or more microwave interactive elements at the peripheral margin of the blank.

20. The method of claim 18 further comprising controlling the liquid molding material entering the first cavity through a first one of the ports independently from the liquid molding material entering the first cavity through a second one of the ports.

21. The method of claim 20 wherein controlling the liquid molding material comprises controlling a length of time during which the liquid molding material is directed into the first cavity.

22. The method of claim 20 wherein controlling the liquid molding material comprises controlling a pressure of the liquid molding material.

23. The method of claim 20 wherein controlling the liquid molding material comprises controlling a volume of the liquid molding material directed into the first cavity.

24. The method of claim 18, wherein inserting the blank into the mold assembly comprises pinching the remaining portion of the blank between the first blank receiving face and the second blank receiving face.

25. The method of claim 18, wherein directing the liquid molding material into the first cavity comprises directing the liquid molding material into a base portion of the first cavity prior to directing the liquid molding material into a sidewall portion and a rim portion.

26. The method of claim 25, further comprising substantially equalizing a first flow front and a second flow front of the liquid molding material on the opposing sides of the peripheral margin of the blank.
